(19) United States
(12) Patent Application Publication
(10) Pub. No.: US 2026/0001069 A1
(43) Pub. Date: Jan. 1, 2026

(54) Dual Channel Assay Cartridges and Methods for Using the Same

(71) Applicant: IDEXX Laboratories, Inc., Westbrook, ME (US)

(72) Inventor: Jeremy Hammond, Standish, ME (US)

(73) Assignee: IDEXX Laboratories, Inc., Westbrook, ME (US)

(21) Appl. No.: 19/250,152

(22) Filed: Jun. 26, 2025

Related U.S. Application Data
(60) Provisional application No. 63/664,252, filed on Jun. 26, 2024.

(51) Int. Cl. B01L 3/00; G01N 21/64

(52) U.S. Cl. CPC B01L 3/502; G01N 21/6428; B01L 2200/026; B01L 2200/04; B01L 2200/16; B01L 2300/02; B01L 2300/0654

(57) ABSTRACT

A cartridge includes a sample inlet, a first fluidic chamber in communication with the sample inlet and in contact with a first plurality of capture molecules, a first waveguide structurally configured to be optically coupled to a first illumination beam of electromagnetic energy, wherein the first waveguide has a first refractive index, a second fluidic chamber separate from the first fluidic chamber, the second fluidic chamber in fluid communication with the sample inlet and in contact with a second plurality of capture molecules, and a second waveguide structurally configured to be optically coupled to a second illumination beam of electromagnetic energy, wherein the second waveguide has a second refractive index that is different than the first refractive index.

### CROSS-REFERENCE TO RELATED APPLICATIONS

This application claims the benefit of co-pending U.S. Provisional Patent Application Ser. No. 63/664,252, filed Jun. 26, 2024 entitled “Dual Channel Assay Cartridges and Methods for Using the Same,” which is hereby incorporated by reference in its entirety.

### FIELD OF THE DISCLOSURE

The present disclosure pertains to diagnosis of disease. More particularly, the present disclosure relates to the use of system for rapid detection of multiple disease markers. A system for detection of analytes, including those identified for immunodiagnostic applications, is disclosed. The system includes a cartridge containing optical waveguides and a reader instrument including an imaging system for reading light signal from the cartridge.

### BACKGROUND

Early detection of a disease is often critical for successful control and treatment of the disease. Providing accurate, high speed, and low-cost blood analysis, infection diagnosis, pathogen detection, or other biological or chemical analyte detection remains a major challenge for health providers and hazardous response teams. This challenge is particularly acute for point-of-care (“POC”) environments, where variable environmental conditions are common, testers may have limited training, and practice of test procedures may be significantly different between testers. Such variation is of particular concern for tests offering quantitative or semi-quantitative results, which can critically depend on standardized sample preparation and readout.

### SUMMARY

Embodiments according to the present disclosure are directed to systems and methods for testing for multiple disease markers utilizing a cartridge with multiple optical waveguides. By utilizing multiple optical waveguides, different wavelengths of energy can be utilized simultaneously to identify different disease markers that react with the different wavelengths of energy. Embodiments described herein include cartridges with multiple fluidic chambers to limit cross-reactivity of disease markers.

In one embodiment, a cartridge comprises a sample inlet, a first fluidic chamber in communication with the sample inlet and in contact with a first plurality of capture molecules, a first waveguide structurally configured to be optically coupled to a first illumination beam of electromagnetic energy, wherein the first waveguide has a first refractive index, a second fluidic chamber separate from the first fluidic chamber, the second fluidic chamber in fluid communication with the sample inlet and in contact with a second plurality of capture molecules, and a second waveguide structurally configured to be optically coupled to a second illumination beam of electromagnetic energy, wherein the second waveguide has a second refractive index that is different than the first refractive index.

In another embodiment, a method for performing an assay includes introducing a first illumination beam having a first wavelength into a first waveguide of a cartridge, the cartridge comprising a sample inlet, engaging at least one capture molecule of a first plurality of capture molecules with the first illumination beam, wherein the first plurality of capture molecules are positioned in a first fluidic chamber of the cartridge in communication with the sample inlet, introducing a second illumination beam having a second wavelength into a second waveguide of the cartridge, wherein the second wavelength is different from the first wavelength, engaging at least one capture molecule of a second plurality of capture molecules with the second illumination beam, wherein the second plurality of capture molecules are positioned in a second fluidic chamber of the cartridge in communication with the sample inlet, wherein the second fluidic chamber is separate from the first fluidic chamber, and detecting a signal from the first fluidic chamber or the second fluidic chamber.

In another embodiment, a reader instrument includes an illumination module structurally configured to emit a first illumination beam having a first wavelength and a second illumination beam having a second wavelength that is different from the first wavelength, a housing at least partially surrounding the illumination module, the housing defining aperture for receiving a cartridge comprising a sample inlet, a first fluidic chamber in communication with the sample inlet and in contact with a first plurality of capture molecules, a first waveguide structurally configured to be optically coupled to the first illumination beam, a second fluidic chamber separate from the first fluidic chamber, the second fluidic chamber in fluid communication with the sample inlet and in contact with a second plurality of capture molecules, and a second waveguide structurally configured to be optically coupled to the second illumination beam, and an imaging system structurally configured to capture images of light signals from the cartridge.

The features, functions, and advantages that have been discussed can be achieved independently in various examples or may be combined in yet other examples. Further details of the examples can be seen with reference to the following description and drawings.

### BRIEF DESCRIPTION OF THE FIGURES

The above, as well as additional features will be better understood through the following illustrative and non-limiting detailed description of example embodiments, with reference to the appended drawings.

FIG. 1 schematically depicts a reader instrument with an insertable cartridge, according to one or more embodiments shown and described herein;

FIG. 2 schematically depicts a section view of the reader instrument of FIG. 1 with the cartridge inserted, according to one or more embodiments shown and described herein;

FIG. 3 schematically depicts a perspective view of the cartridge of FIG. 1, according to one or more embodiments shown and described herein;

FIG. 4 schematically depicts a top view of the cartridge of FIG. 1, according to one or more embodiments shown and described herein;

FIG. 5 schematically depicts a side view of the cartridge of FIG. 1, according to one or more embodiments shown and described herein;

FIG. 6 schematically depicts a bottom view of the cartridge of FIG. 1, according to one or more embodiments shown and described herein;

FIG. 7A schematically depicts a side view of a first waveguide of the cartridge of FIG. 1, according to one or more embodiments shown and described herein;

FIG. 7B schematically depicts a side view of a second waveguide of the cartridge of FIG. 1, according to one or more embodiments shown and described herein;

FIG. 8 schematically depicts a perspective view of a flow plate of the cartridge of FIG. 1, according to one or more embodiments shown and described herein;

FIG. 9 schematically depicts a side view of the flow plate of FIG. 8 and the waveguides of the cartridge of FIG. 7A and FIG. 7B, according to one or more embodiments shown and described herein;

FIG. 10 schematically depicts an exploded view of the cartridge of FIG. 1, according to one or more embodiments shown and described herein;

FIG. 11 schematically depicts an inverted exploded view of the cartridge of FIG. 1, according to one or more embodiments shown and described herein;

FIG. 12 schematically depicts a side section view of the cartridge of FIG. 1 inserted into the reader instrument of FIG. 1, according to one or more embodiments shown and described herein; and

FIG. 13 schematically depicts a top view section view of the cartridge of FIG. 1 inserted into the reader instrument of FIG. 1, according to one or more embodiments shown and described herein.

All the figures are schematic, not necessarily to scale, and generally only show parts which are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers refer to the same or similar elements or components throughout.

Within examples, the present disclosure is directed to devices, systems, and methods for testing a sample (e.g., a biological sample) utilizing a cartridge.

In one embodiment, a system includes a cartridge and a reader instrument that reads and processes data obtained from the cartridge. In embodiments, the cartridge comprises a sample inlet and a first fluidic chamber in communication with the sample inlet and in contact with a first plurality of capture molecules. The cartridge, in embodiments, includes a first waveguide structurally configured to be optically coupled to a first illumination beam of electromagnetic energy, wherein the first waveguide has a first refractive index. In embodiments, the cartridge includes a second fluidic chamber separate from the first fluidic chamber, the second fluidic chamber in fluid communication with the sample inlet and in contact with a second plurality of capture molecules. The cartridge, in embodiments, also includes and a second waveguide structurally configured to be optically coupled to a second illumination beam of electromagnetic energy, wherein the second waveguide has a second refractive index that is different than the first refractive index. By including the first waveguide and the second waveguide, capture molecules that are structurally configured to react with the first illumination beam as well as capture molecules that are structurally configured to react with the second illumination beam may be interrogated simultaneously. Moreover, by including the first fluidic chamber and the second fluidic chamber, capture molecules with cross-reactivity can be positioned in separate fluidic chambers such that interference can be limited. This and other embodiments are described herein with reference to the figures.

The term “capture molecule” is used herein to describe any of a variety of molecules that could be attached to a surface for performing a useful assay. The capture molecules may be a peptide, a polypeptide, a protein, an antibody, an antigen, an aptamer, a polysaccharide, a sugar molecule, a carbohydrate, a lipid, an oligonucleotide, a polynucleotide, a synthetic molecule, an inorganic molecule, an organic molecule, and/or combination thereof. The terms “polypeptide,” “peptide,” and “protein” may be used interchangeably in this disclosure. The terms “oligonucleotide,” and “polynucleotide” may also be used interchangeably in this disclosure. For purpose of this disclosure, when referring to a polypeptide or a polynucleotide molecule, it is intended that either the full-length molecule or a fragment of the full-length molecule may be used. Moreover, any mutated forms of a polypeptide (antigen) or the DNA molecule encoding such a polypeptide are also within the scope of the disclosure, if such mutation or mutations do not reside within any epitope of the polypeptide (antigen), or if the mutation or mutations do not substantially decrease the binding affinity between the polypeptide (antigen) and a specific antibody against the polypeptide or a fragment thereof. Plural or singular forms of a noun may be used interchangeably unless otherwise specified in the disclosure. Capture molecules may also be in the form of a molecular mixture. For example, a cell lysate preparation containing a mixture of molecules may be utilized.

For the purpose of this disclosure, the method and system described are based on assays that use fluorescence signal to quantify analyte(s) present in a sample. However, the embodiments described herein may be applicable to assays beyond fluorescence-based signal transduction. In addition, the method and system may also be compatible with luminescence, phosphorescence, and light scattering based signal transduction. In exemplary embodiments, excitable tags may be used as detection reagents in assay protocols. Exemplary tags include, but are not limited to, fluorescent organic dyes such as fluorescein, rhodamine, and commercial derivatives such as Alexa dyes (Life Technologies) and DyLight products; fluorescent proteins such as R-phycoerythrin and commercial analogs such as SureLight P3; luminescent lanthanide chelates; luminescent semiconductor nanoparticles (e.g., quantum dots); phosphorescent materials, and microparticles that incorporate these excitable tags. For the purpose of this disclosure, the term “fluorophore” is used generically to describe all of the excitable tags listed above.

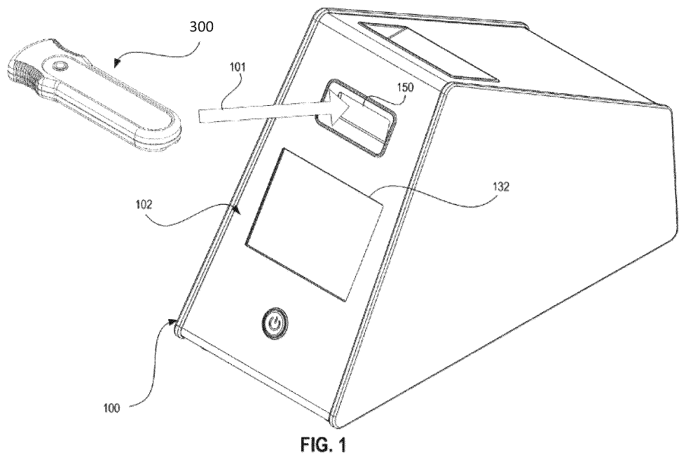

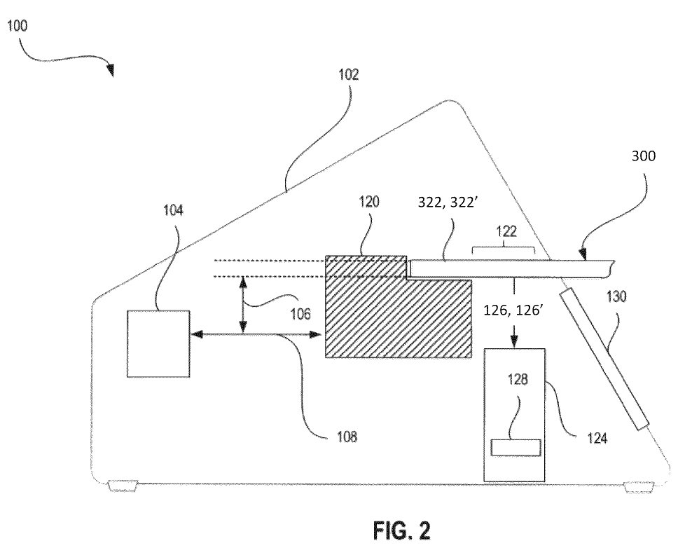

Referring now to FIGS. 1 and 2, a reader instrument 100 for analyte detection is schematically depicted. A cartridge 300 is insertable into the reader instrument 100 as indicated by an arrow 101. The reader instrument 100, in embodiments, includes a housing 102 that defines an aperture 150 for receiving cartridge 300. In some embodiments, the reader instrument 100 includes a user interface 132, such as a screen, a touchscreen, or the like.

The reader instrument 100 may be used for rapid detection or quantitation of analytes in a sample in various settings including, but not limited to, veterinary clinics, medical clinics, centralized laboratory facilities, public health laboratories, remote and/or low resource settings, and mobile monitoring units. The sample may be a biological or environmentally derived fluid, including for example and without limitation, sputum, tears, urine, blood, serum, plasma, fine needle aspirate, fecal matter, or any other suitable sample for analyte testing. That is, the sample may be a fluidic sample from a human, a non-human animal, or otherwise obtained from the environment or from an industrial process. Although shown as a standalone unit, in some embodiments, the reader instrument 100 may be integrated with other computing entities or laboratory or processing equipment, including modules for automatic sample preparation, sample storage or containment, or additional laboratory testing.

Referring to FIG. 2, the reader instrument 100 includes the housing 102 and an illumination module 104 is positioned at least partially within the housing 102. In embodiments, the illumination module 104 includes one or more emitters, such as light amplification by stimulated emission of radiation (LASER) emitters or the like that emit electromagnetic energy. In some embodiments, the illumination module 104 includes multiple LASER emitters that emit electromagnetic energy at different wavelengths, as described in greater detail herein. In some embodiments, the illumination module 104 may be offset vertically (as indicated by a double-headed arrow 106) and/or longitudinally (as indicated by a double-headed arrow 108) from the cartridge 300 when the cartridge 300 is positioned at least partially within the housing 102. In embodiments, the cartridge 300 includes one or more refractive volumes 120 coupled to waveguides 322, 322′. In some embodiments, the one or more refractive volumes 120 are integral with the waveguides 322, 322′. In some embodiments, the one or more refractive volumes 120 are separate from the waveguides 322, 322′ and transmit electromagnetic energy from the illumination module 104 to the waveguides 322, 322′.

The illumination module 104 may include lenses, refractive or reflective elements, spatial or intensity patterning elements, and/or beam diffusers or homogenizers that condition and direct light emitted from the emitters (e.g., the LASER emitters) of the illumination module 104. In some embodiments, the illumination module 104 includes one or more rotating beam homogenizer elements that reduce speckle. In some embodiments, the beam homogenizer elements may be omitted, or alternately formed using piezoelectric, acoustic or other time and/or spatially varying optical elements that reduce speckle without requiring large scale rotational, oscillatory, or random motion of optical elements.

In the illustrated embodiment, the waveguides 322, 322′ are capable of transmitting LASER light directly, or through total internal reflection, to an assay region 122 of the cartridge 300. In one embodiment, cartridge 300 incorporates a microarray of proteins, such as recombinant antigens and antibody controls, in two or more channels, and can provide multiple parallel fluorescence assay results from a single sample, as described in greater detail herein.

The reader instrument 100 may include an interlock switch that electrically disengages light emitting circuitry of the illumination module 104 when the cartridge 300 is not inserted or is only partially inserted. In some embodiments, the reader instrument 100 may be fitted with an opaque door that closes when cartridge is fully extracted from actuator. Additional baffles and light blocking elements incorporated into reader instrument 100 or cartridge 300 may minimize the amount of stray light power that is emitted external to housing 102 when cartridge 300 is inserted.

An imaging system 124 is used to capture images of light signals 126, 126′ emitted from the assay region 122 of the waveguides 322, 322′, respectively, of the cartridge 300. A sensor 128, such as a two-dimensional sensor charge coupled device (“CCD”) or complementary metal-oxide-semiconductor (“CMOS”) sensor, as well as any imaging optics components may be mounted with respect to illumination module 104 and to housing 102. The imaging system 124 may include one or more imaging optics, such as lenses, refractive or reflective elements, phase-modifying elements, and spatial- or intensity-patterning elements having both sufficient field of view and depth of field to simultaneously image the entire assay region. In some embodiments, a variable focus lens may be used to enable adjustable focusing on various regions. In some embodiments and as shown in FIG. 2, the imaging system 124 may be oriented with its optical axis transverse to the plane of waveguides 322, 322′. In embodiments, the imaging system 124 may be configured to image the assay region 122 through waveguides 322, 322′. As described in greater detail herein, in some embodiments, the field of view may be even larger than the assay region 122 of the cartridge 300, allowing capture of fiducial markers, cartridge tracking information, or other desirable cartridge identification indicia (e.g., barcodes).

In the illustrated embodiment, the waveguides 322, 322′ are capable of transmitting LASER light directly, or through total internal reflection, to the assay region 122. In one embodiment, cartridge 300 incorporates capture molecules such as an microarray of biomarkers, including printed proteins (e.g., natural, purified, or recombinant antigens, antibodies, and/or controls) in fluidic channels, and is capable of providing multiple parallel fluorescence assay results from a single sample. The cartridge 300 includes fluidic channels with an inlet port and an outlet port, and may be formed as a single piece or separate pieces that cooperate to define the channels, as described in greater detail herein.

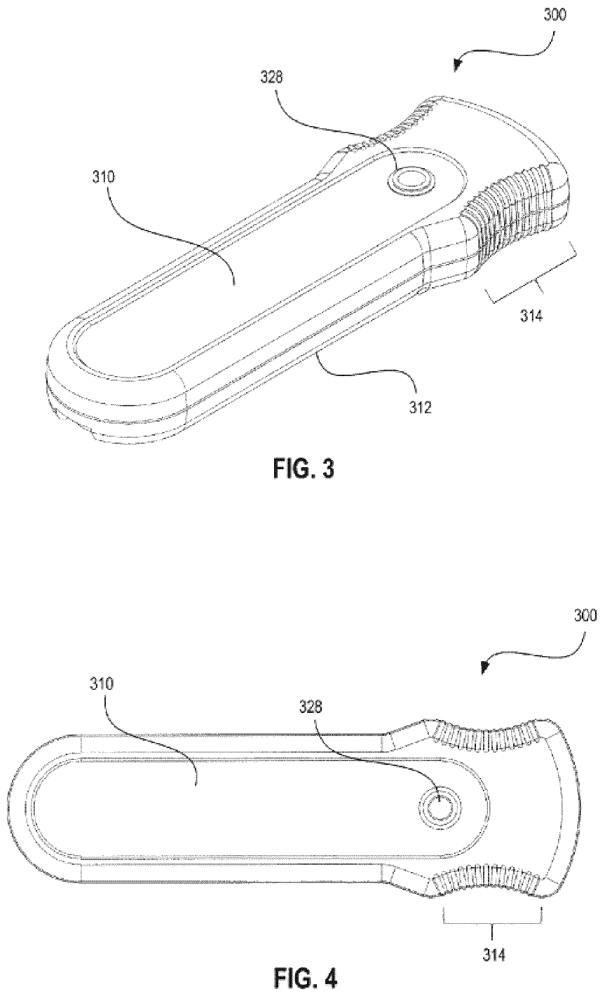

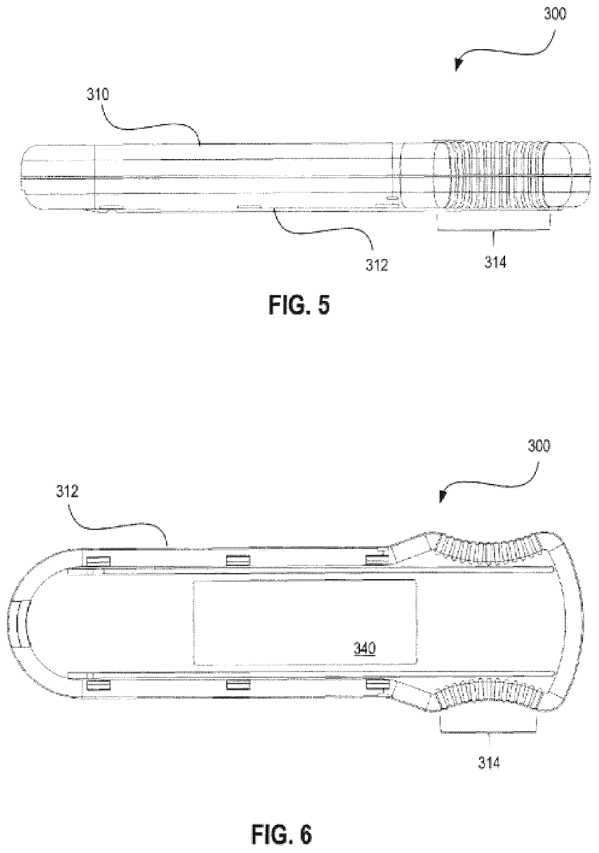

A perspective view of the cartridge 300 is shown in FIG. 3, a top view in FIG. 4, a side view in FIG. 5, and a bottom view in FIG. 6. As may be seen in FIGS. 3-5, in some embodiments, the cartridge 300 includes a first piece 310 coupled to a second piece 312. Textured grooves 314 in the first and/or second pieces 310 and 312, respectively, may assist a user in gripping the cartridge 300. The cartridge 300 may be formed from a moldable plastic or the like that may be color coded or marked with tracking indicia. In some embodiments, adhesive strips with alphanumeric labeling, bar codes, or other tracking indicia may be affixed to cartridge 300. In embodiments, the cartridge 300 defines an inlet port 328 (FIG. 4) and a window 340 (FIG. 6) on an opposite side of the cartridge 300 of the inlet port 328. Liquid sample can be introduced into the cartridge 300 through the inlet port 328, as described in greater detail herein. In embodiments, the window 340 allows imaging access to an interior of the cartridge 300, as described in greater detail herein.

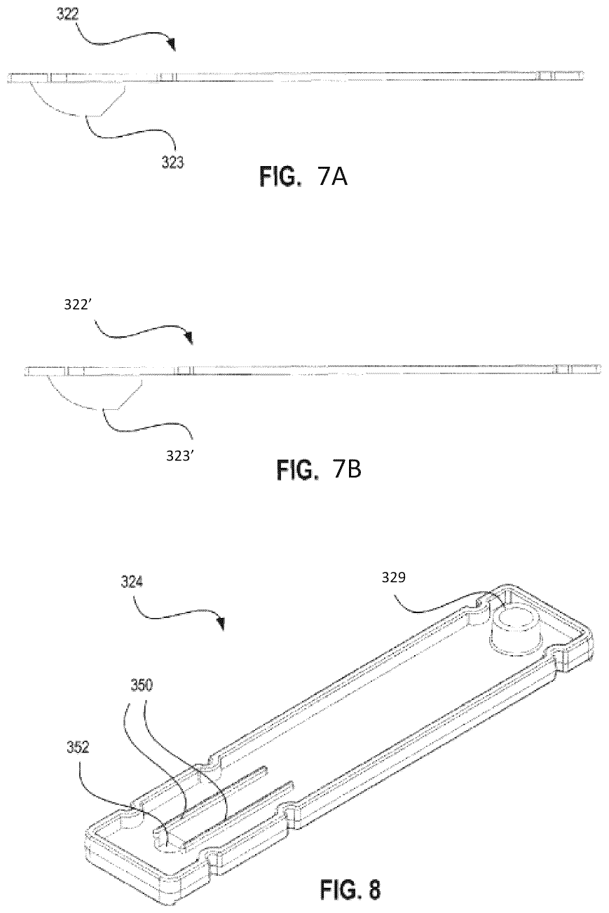

Referring to FIGS. 7A and 7B, the first waveguide 322 and the second waveguide 322′ are depicted, respectively. As noted hereinabove, in embodiments, the first waveguide 322 and the second waveguide 322′ are positioned within the cartridge 300. LASER light can propagate through the first waveguide 322 and the second waveguide 322′, such as through direct transmission or total internal reflection. In the embodiment depicted in FIGS. 7A and 7B, the first waveguide 322 and the second waveguide 322′ are depicted as having similar dimensions, however, it should be understood that this is merely an example. In embodiments, the first waveguide 322 and the second waveguide 322′ may have different optical properties. For example, in some embodiments, the first waveguide 322 and the second waveguide 322′ have different refractive indices. Because the first waveguide 322 and the second waveguide 322′ have different properties (e.g., different refractive indices), different wavelengths of electromagnetic energy may propagate (directly or via total internal reflection) through the first waveguide 322 as compared to the second waveguide 322′. For example, in embodiments, the first waveguide 322 has a first refractive index that allows a first wavelength of electromagnetic energy to propagate through the first waveguide 322 (directly or via total internal reflection). The second waveguide 322′ has a second refractive index that is different than the first refractive index of the first waveguide 322. The second refractive index of the second waveguide 322′ allows a second wavelength of electromagnetic energy that is different from the first wavelength of electromagnetic energy to propagate through the second waveguide 322′ (directly or via total internal reflection). Because the first and second waveguides 322, 322′ have different refractive indices and allow propagation of different wavelengths of electromagnetic energy, the first and second waveguides 322, 322′ can be utilized to illuminate different capture molecules.

For example and without being bound by theory, different capture molecules may react with different wavelengths of electromagnetic energy. A first capture molecule, for example, might react with the first wavelength of electromagnetic energy while a second capture molecule might react with the second wavelength of electromagnetic energy that is different from the first wavelength of electromagnetic energy. By contrast, the first capture molecule might not react with the second wavelength of electromagnetic energy. Similarly, the second capture molecule might not react with the first wavelength of electromagnetic energy. Put another way, in some examples, different capture molecules react to mutually exclusive wavelengths of magnetic energy. By including the first and second waveguides 322, 322′ having the first and second refractive indices, respectively, a single cartridge 300 may be utilized to perform multiple assays with capture molecules that react to mutually exclusive wavelengths of electromagnetic energy.

In embodiments, the first waveguide 322 includes a first lens 323, and the second waveguide 322′ includes a second lens 323′. Electromagnetic energy, e.g., LASER light from the illumination module 104 (FIG. 1) can be introduced into the first waveguide 322 and the second waveguide 322′ via the first lens 323 and the second lens 323′, respectively. In embodiments, the first lens 323 and the second lens 323′ have different refractive indices from one another. For example, in embodiments, the first lens 323 has a first lens refractive index and the second lens 323′ has a second lens refractive index that is different from the first lens refractive index.

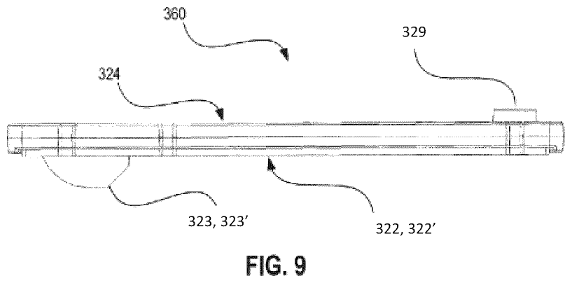

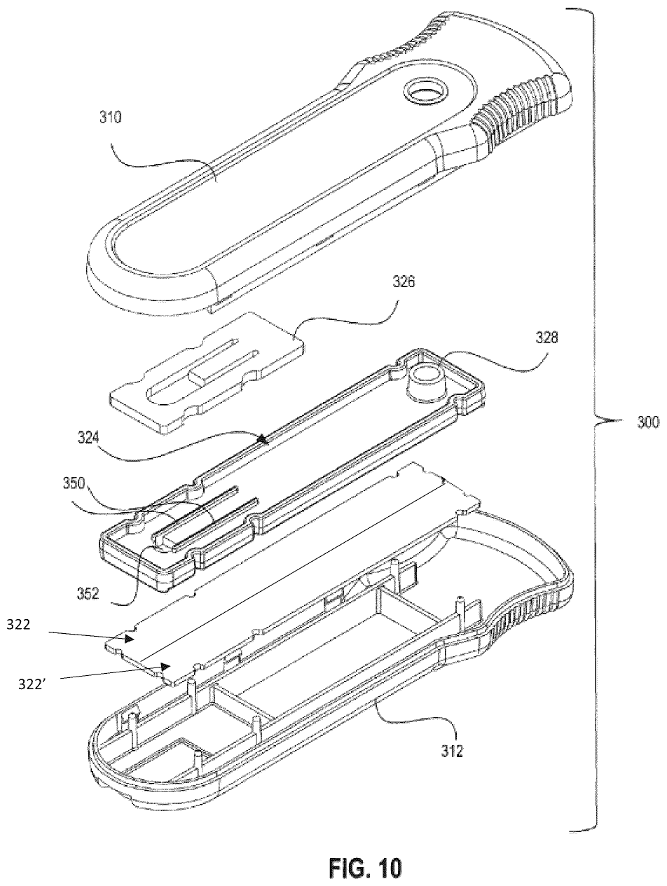

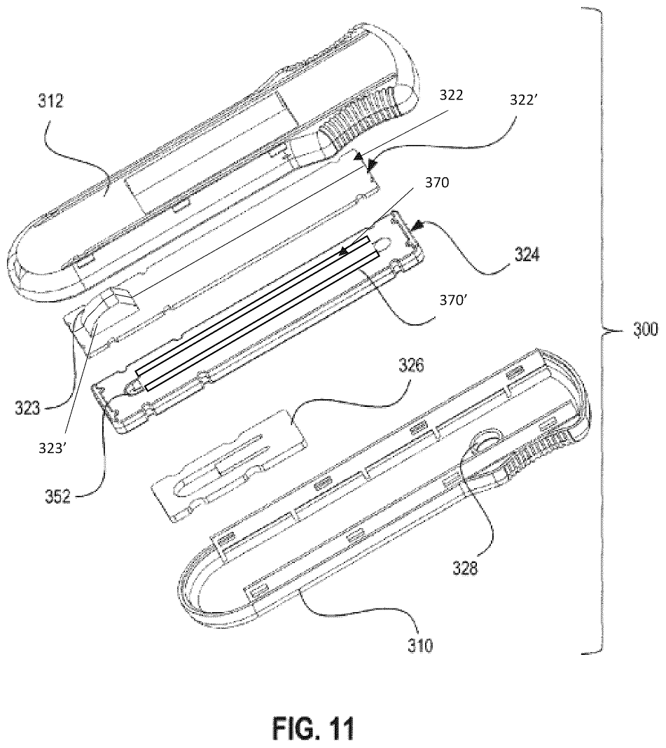

Referring to FIGS. 8 and 9, a flow plate 324 with a flow plate sample inlet port 329, rails 350, and an outlet port 352, is engageable with waveguides 322, 322′ (FIGS. 7A and 7B). In some embodiments, the flow plate 324 is coupled to the waveguides 322, 322′, for example and without limitation, using laser welding, chemical or adhesive attachment or other suitable, arrangement to form an assembly 360. The assembly 360 may be positioned within cartridge 300. In some embodiments, a wick pad 326 for waste containment is positioned within the cartridge 300, as seen in top and bottom exploded perspective views of FIGS. 10 and 11.

FIG. 10 shows an exploded perspective view of the components of cartridge 300, including, from the top of the figure, the upper piece 310, the wick pad 326, the flow plate 324, the first and second waveguides 322, 322′ and the lower piece 312. FIG. 11 is another exploded perspective view of the components of cartridge 300, this time as viewed with lower piece 312 at the top of the figure, shown here to illustrate the features on the underside of the components, such as lenses 323, 323′ on the underside of waveguides 322, 322′ and grooves 370, 370′ on the underside of flow plate 324. The grooves 370, 370′, when positioned against waveguide 322, 322′, respectively, define empty fluidic channels into which sample may be inserted from input port 328 and flows through the fluidic channel to outlet port 352. Use of waveguides 322, 322′ that are separately manufactured from upper piece 310 and lower piece 312 may allow for reduced overall cost and/or increased design flexibility than embodiments in which the waveguide and peripherals (e.g., clamshell or equivalent protective elements) are fabricated together.

The components include a variety of features, such as notches and protrusions, to assist with the alignment of the components with respect to each other. These alignment features may be modified from those shown in FIGS. 10 and 11 while remaining within the spirit of the present disclosure.

In some embodiments, the cartridge 300 may be marked with identifying indicia such as cartridge parameters, cartridge type, print geometry and layout, print lot, serial number, and expiration date, either by direct printing onto the cartridge 300 or by attachment of a sticker or the like, printed with identifying information. This marking allows for accurate cartridge identification and tracking based on, for example, one or two dimensional bar codes, RFID readers, or other available tracking technologies. In other embodiments, cartridge affixed RFID, or other tracking technology may be contemplated.

In some embodiments, the cartridge 300 may include a location for accepting sample-specific identifying information. In another embodiment, the cartridge may have a region for accepting hand-written identifying information. In one embodiment, the cartridge 300 may have a region for applying a label, including barcodes or other sample-specific labels, for identifying the sample being processed on that cartridge.

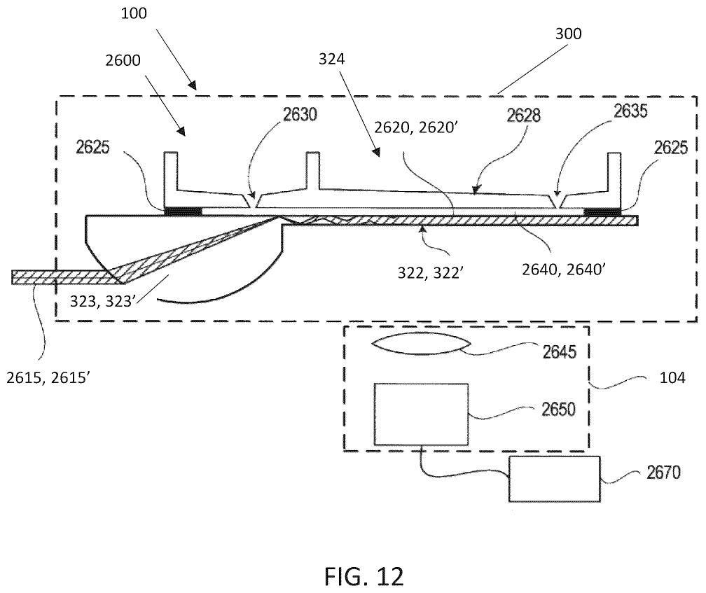

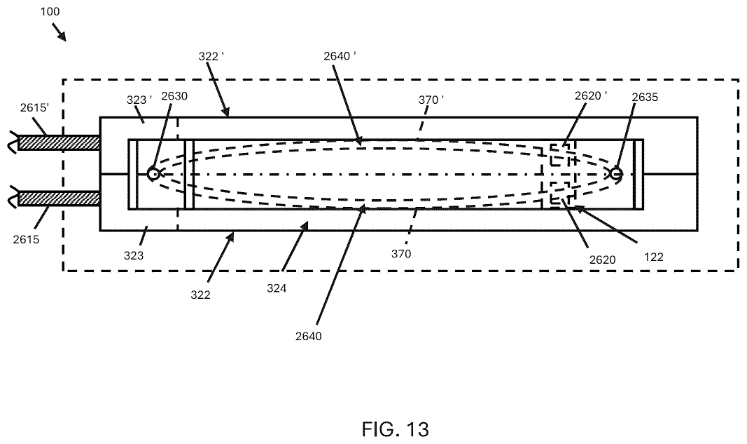

Referring to FIGS. 12 and 13, a section view and a top view of the cartridge 300 in the reader instrument 100 is schematically depicted, respectively. The cartridge 300 includes the waveguides 322, 322′ with the lenses 323, 323′ suitable for use with an antigen assay. A first illumination beam 2615 is inserted into the first waveguide 322 through the first lens 323. A second illumination beam 2615′ is inserted into the second waveguide 322′ through the second lens 323′. The first illumination beam 2615 and the second illumination beam 2615′ may be provided, for example, by a LASER or LASERS with appropriate wavelengths to excite fluorescent labels at a first assay surface 2620 and a second assay surface 2620′. In embodiments, the first illumination beam 2615 and the second illumination beam 2615′ are provided from the illumination module 104 (FIG. 1). Other appropriate forms of illumination, either collimated or uncollimated, may also be used with the assay system 2600.

The first lens 323 is configured to cooperate with the first waveguide 322 such that the first illumination beam 2615, so inserted, is guided through the first waveguide 322 and may illuminate the first assay surface 2620 in the assay region 122 by evanescent light coupling. The first assay surface 2620, an upper component 2628 of the flow plate 324, which includes an inlet port 2630 and an output port 2635, cooperate to define a first fluidic sample chamber 2640. In embodiments, the inlet port 2630 of the upper component 2628 is aligned with the inlet port 328 (FIG. 3) of the first piece 310 (FIG. 3) of the cartridge 300 and sample can be introduced into the first fluidic sample chamber 2640 via the inlet port 328 (FIG. 3) of the first piece 310 (FIG. 3).

The first assay surface 2620 and upper element 2628 can be bonded via a channel-defining adhesive gasket 2625 or via direct bonding methods such as laser welding, ultrasonic welding, or solvent bonding. Appropriate chemical compounds (such as a printed antigen) are bound to the first assay surface 2620 such that when a biological sample and labeled detect reagent are added to the first fluidic sample chamber 2640, a target analyte, if present, forms a sandwich between its specific labeled detect reagent and its specific chemical compound immobilized on the first assay surface 2620. If the specific complex is formed at the first assay surface 2620, fluorescence signal at the immobilized compound location is indicative of the presence of the target analyte within the biological sample.

The second lens 323′ is configured to cooperate with the second waveguide 322′ such that the second illumination beam 2615′, so inserted, is guided through the second waveguide 322′ and may illuminate the second assay surface 2620′ in the assay region 122 by evanescent light coupling. The second assay surface 2620′ and the upper component 2628 cooperate to define a second fluidic sample chamber 2640′.

The second assay surface 2620′ and upper element 2628 can be bonded via the channel-defining adhesive gasket 2625 or via direct bonding methods such as laser welding, ultrasonic welding, or solvent bonding. Appropriate chemical compounds (such as a printed antigen) are bound to the second assay surface 2620′ such that when a biological sample and labeled detect reagent are added to the second fluidic sample chamber 2640′, a target analyte, if present, forms a sandwich between its specific labeled detect reagent and its specific chemical compound immobilized on the second assay surface 2620′. If the specific complex is formed at the second assay surface 2620′, fluorescence signal at the immobilized compound location is indicative of the presence of the target analyte within the biological sample.

Referring to FIG. 12, collection and filtering optics 2645 may be used to capture the fluorescence signal from the first assay surface 2620 and the second assay surface 2640′. A signal corresponding to the fluorescence so captured may then be directed to an imaging device 2650, such as a CCD or CMOS sensor.

Referring to FIGS. 2. 12, and 13, in one embodiment, cartridge 300 supports a multiplexed fluorescence bioassay including a printed array of biomarkers immobilized on a waveguide contacting surface (e.g., assay region 122) that forms a portion of cartridge 300. Typically, prior to insertion into reader instrument 100, the sample and other assay reagents can be added to cartridge 300 according to an assay protocol. After processing, the processed cartridge 300 is then inserted into reader instrument 100, which illuminates the waveguides 370, 370′ at one or more different exposure times, ranging from milliseconds to seconds. Emitted fluorescence from the biomarker array is optically collected, imaged, and analyzed within a few seconds to minutes. An embedded or external microprocessor may analyze the recorded image.

As described hereinabove, in embodiments, the chemical compounds (e.g., capture molecules) bound to the second assay surface 2620′ are different chemical compounds (e.g., capture molecules) than those bound to the first assay surface 2620. More particularly, in some embodiments, the chemical compounds bound to the second assay surface 2620′, if the sandwich/specific complex is formed at the second assay surface 2620′, are structurally configured to fluoresce via excitation at the wavelength of the second illumination beam 2615′. By contrast, the chemical compounds bound to the first assay surface 2620, if the sandwich/specific complex is formed at the first assay surface 2620, are structurally configured to fluoresce via excitation at the wavelength of the first illumination beam 2615. In some embodiments, the chemical compounds bound to the first assay surface 2620, if the sandwich/specific complex is formed at the first assay surface 2620, may not fluoresce via excitation at the wavelength of the second illumination beam 2615′. Likewise, in some embodiments, the chemical compounds bound to the second assay surface 2620′, if the sandwich/specific complex is formed at the second assay surface 2620′, may not fluoresce via excitation at the wavelength of the first illumination beam 2615.

Because the cartridge 300 includes multiple assay surfaces, and the illumination module 104 (FIG. 2) of the reader instrument 100 (FIG. 1) emits multiple illumination beams at different wavelengths, the disclosed system can perform assays with capture molecules that would conventionally require multiple cartridges and/or multiple reader instruments.

Moreover, because the cartridge includes multiple assay surfaces separated in different fluidic chambers, otherwise cross-reactive capture molecules can be utilized in the same cartridge 300. For example, in some embodiments, individual compounds (e.g., capture molecules) of the chemical compounds bound to the first assay surface 2620 have limited cross-reactivity with other individual compounds bound to the first assay surface 2620. Likewise, individual compounds (e.g., capture molecules) of the chemical compounds bound to the second assay surface 2620′ may have limited cross-reactivity with other individual compounds bound to the second assay surface 2620′. In some instances, however, the chemical compounds bound to the first assay surface 2620 may be or may have at least some cross-reactivity with chemical compounds bound to the second assay surface 2620′. As noted above, the second assay surface 2620′ is positioned in the second fluidic chamber 2640′ separate from the first assay surface 2620 positioned in the first fluidic chamber 2640. Accordingly, despite having at least some cross-reactivity, because the second assay surface 2640′ is separated from the first assay surface 2640, an assay can be simultaneously performed with the capture molecules bound to the second assay surface 2640′ and the first assay surface 2640 without significantly impacting the performance of the assay. In this additional way, by the cartridge 300 can perform simultaneous assays on capture molecules that would conventionally require multiple cartridges 300.

Overall operation of reader instrument 100 may be controlled through a user interface 130, which may include a touchscreen, barcode reader, operable connection to a separate computer with its own interface (not shown), and/or conventional button, toggles, switches, keyboard, voice/audio control, or other human-machine interface. In diagnostic applications, a cartridge may be processed with a sample according to clinical assay protocol specific to the cartridge being tested. The cartridge is then inserted into the reader instrument. Cartridge parameters (e.g., type, print geometry and layout, print lot, cartridge serial number, and expiration date) may be automatically read, as cartridge parameters may be encoded on the cartridge in the form of a barcode or other information indicia. The sample identifier may be input via user interface 130 into reader instrument 100. Alternatively, the sample identifier may be read automatically. For example, a user may write information on the cartridge by hand or apply identifiers such as barcode stickers to the cartridge, which are in turn imaged or read by the reader instrument. In an embodiment, a sample record, which links cartridge parameters and sample identifier information, may be automatically generated by the reader instrument. Simultaneous cartridge and sample identifier reading in the reader instrument at the time of a measurement provides quality assurance advantages over systems that rely on manual linkage of this information.

Upon insertion, reader instrument may automatically acquire and analyze fluorescent images from imaging system 124 and cartridge 300. This image-derived data may be analyzed to determine qualitative presence of an analyte, semi-quantitative or quantitative evaluation of analyte concentration, or even infection/disease diagnoses. Analysis results may be displayed on user interface 130, such as a front panel display, printed, stored in memory, or transmitted to an information management system for later review.

In addition to operation simplicity, reader instrument 100 has other advantages based on its design. Generally, it is easier to manufacture and maintain devices that have few or no moving parts. Advantageously, reader instrument 100 may be constructed to have few or no moving parts. The illumination module 104, and imaging system 124 may be constructed of non-moving parts that are fixed with respect to each other in operation. Shock or drop performance of reader instrument 100 is also improved by limiting the number of moving parts, making reader instrument 100 more suitable for use in field or portable applications.

Various aspects and embodiments have been disclosed herein, but other aspects and embodiments will certainly be apparent to those skilled in the art. Additionally, the various aspects and embodiments disclosed herein are provided for explanatory purposes and are not intended to be limiting, with the true scope being indicated by the following claims.

What is claimed is:

1. A cartridge comprising:
a sample inlet;
a first fluidic chamber in communication with the sample inlet and in contact with a first plurality of capture molecules;
a first waveguide structurally configured to be optically coupled to a first illumination beam of electromagnetic energy, wherein the first waveguide has a first refractive index;
a second fluidic chamber separate from the first fluidic chamber, the second fluidic chamber in fluid communication with the sample inlet and in contact with a second plurality of capture molecules; and
a second waveguide structurally configured to be optically coupled to a second illumination beam of electromagnetic energy, wherein the second waveguide has a second refractive index that is different than the first refractive index.

2. The cartridge of claim 1, wherein the first plurality of capture molecules are different from the second plurality of capture molecules.

3. The cartridge of claim 2, wherein a cross-reactivity between individual capture molecules of the first plurality of capture molecules is less than a cross-reactivity between the first plurality of capture molecules and the second plurality of capture molecules.

4. The cartridge of claim 1, further comprising a first lens optically coupled to the first waveguide.

5. The cartridge of claim 4, further comprising a second lens optically coupled to the second waveguide.

6. The cartridge of claim 5, wherein the first lens has a first lens refractive index and the second lens has a second lens refractive index that is different from the first lens refractive index.

7. The cartridge of claim 1, wherein the first fluidic chamber is defined by the first waveguide and a flow plate coupled to the first waveguide.

8. The cartridge of claim 7, wherein the second fluidic chamber is defined by the second waveguide and the flow plate coupled to the second waveguide.

9. A method for performing an assay, the method comprising:
introducing a first illumination beam having a first wavelength into a first waveguide of a cartridge, the cartridge comprising a sample inlet;
engaging at least one capture molecule of a first plurality of capture molecules with the first illumination beam, wherein the first plurality of capture molecules are positioned in a first fluidic chamber of the cartridge in communication with the sample inlet;
introducing a second illumination beam having a second wavelength into a second waveguide of the cartridge, wherein the second wavelength is different from the first wavelength;
engaging at least one capture molecule of a second plurality of capture molecules with the second illumination beam, wherein the second plurality of capture molecules are positioned in a second fluidic chamber of the cartridge in communication with the sample inlet, wherein the second fluidic chamber is separate from the first fluidic chamber; and
detecting a signal from the first fluidic chamber or the second fluidic chamber.

10. The method of claim 9, wherein the first plurality of capture molecules are different from the second plurality of capture molecules.

11. The method of claim 9, wherein introducing the first illumination beam into the first waveguide comprises introducing the first illumination beam into a first lens optically coupled to the first waveguide.

12. The method of claim 11, wherein introducing the second illumination beam into the second waveguide comprises introducing the second illumination beam into a second lens optically coupled to the second waveguide.

13. The method of claim 12, wherein the first lens has a first lens refractive index and the second lens has a second lens refractive index that is different from the first lens refractive index.

14. The method of claim 9, wherein a cross-reactivity between individual capture molecules of the first plurality of capture molecules is less than a cross-reactivity between the first plurality of capture molecules and the second plurality of capture molecules.

15. The method of claim 9, wherein detecting the signal from the first fluidic chamber or the second fluidic chamber comprises detecting a fluorescent signal from the first fluidic chamber or the second fluidic chamber.

16. The method of claim 9, further comprising propagating the first illumination beam through the first waveguide via total internal reflection.

17. The method of claim 9, further comprising propagating the second illumination beam through the second waveguide via total internal reflection.

18. A reader instrument comprising:
an illumination module structurally configured to emit a first illumination beam having a first wavelength and a second illumination beam having a second wavelength that is different from the first wavelength;
a housing at least partially surrounding the illumination module, the housing defining aperture for receiving a cartridge comprising a sample inlet, a first fluidic chamber in communication with the sample inlet and in contact with a first plurality of capture molecules, a first waveguide structurally configured to be optically coupled to the first illumination beam, a second fluidic chamber separate from the first fluidic chamber, the second fluidic chamber in fluid communication with the sample inlet and in contact with a second plurality of capture molecules, and a second waveguide structurally configured to be optically coupled to the second illumination beam; and
an imaging system structurally configured to capture images of light signals from the cartridge.

19. The reader instrument of claim 18, wherein the illumination module comprises a first LASER emitter that emits the first illumination beam and a second LASER emitter that emits the second illumination beam.

20. The reader instrument of claim 18, wherein the illumination module comprises one or more beam homogenizer elements.
